(19) United States
(12) Patent Application Publication
(10) Pub. No.: US 2005/0233287 A1
(43) Pub. Date: Oct. 20, 2005

(54) Accessible computer system

(76) Inventors: Vladimir Bulatov, Corvallis, OR (US); John A. Gardner, Corvallis, OR (US); Jeffrey A. Gardner, Eugene, OR (US)

Correspondence Address: CHERNOFF, VILHAUER, MCCLUNG & STENZEL, 1600 ODS TOWER, 601 SW SECOND AVENUE, PORTLAND, OR, 97204-3157, US

(21) Appl. No.: 11/106,144

(22) Filed: Apr. 13, 2005

Related U.S. Application Data
(60) Provisional application No. 60/562,503, filed on Apr. 14, 2004.

(51) Int. Cl. G09B 21/00

(52) U.S. Cl. 434/114

(57) ABSTRACT

An accessible computer system includes a user interface providing audio and tactile output to enhance the accessibility of electronic documents for a visually impaired user of the system.

### CROSS-REFERENCE TO RELATED APPLICATIONS

This application claims the benefit of U.S. Provisional Application No. 60/562,503, filed Apr. 14, 2004.

### BACKGROUND OF THE INVENTION

The present invention relates to a computer system and, more particularly, to a computer system having a user interface adapted to promote accessibility for a-visually impaired user.

Personal computers with graphical, “point and click” style interfaces, have obtained widespread use not only in the business world but also in households. While the graphical interface is credited, in large part, for the widespread acceptance of personal computers, the graphical interface poses significant barriers to visually impaired computer users. In an effort to increase the accessibility of computer systems, hardware and application software have been developed to facilitate communication between personal computers and visually impaired users.

For example, software may include keyboard commands that permit individuals who cannot perceive or have difficulty interpreting displayed images to make use of computers, including accessing the Internet and the Worldwide Web. In some cases, a visually impaired user can use a haptic or tactile pointing device, such as a haptic mouse or a tactile display, to obtain feedback related to the position and shape of images displayed by the computer. However, haptic and tactile devices provide only limited or single point access to a display and are, therefore, most useful for simple graphical displays.

Screen reading systems have been developed that use synthetic or recorded speech to provide audio output of text that is contained in electronic documents or the menus of the graphical user interface (GUI) used to control operation of a computer. However, many electronic documents, particularly documents obtained from the Internet or Worldwide Web, are raster images that do not include text. Further, many documents include graphical elements that are not susceptible to description by a screen reader. It is difficult to incorporate text or some form of audio labeling of graphical elements included in a raster image and authors of electronic documents are reluctant to expend the additional effort and expense to create accessible documents for the limited number of visually impaired users. Moreover, systems providing audio output for accessibility have typically relied on touch to activate the audio output and, generally, have had very low resolution.

Tactile diagrams, typically, comprising a planar sheet with one or more raised surfaces, permit a visually impaired person to feel the positions and shapes of displayed graphical elements and have a lengthy history as aids for the visually impaired. A tactile diagram can be placed on a digitizing pad that records the coordinates of contact with the diagram permitting a visually impaired user to provide input to the computer by feeling the tactile surface and depressing the surface at a point of interest. Further, the development of computer controlled embossers permits a user to locally create a tactile diagram of a document that is of immediate interest to the user. However, it is often difficult for a visually impaired person to make sense of tactile shapes and textures without some additional information to confirm or augment the tactile presentation. For example, it may be difficult to identify a state or country by tactilely tracing its borders on a map. Even if portions of a document are audibly labeled, the visually impaired user may have difficulty locating an element of interest and activating the aural output without tactile labeling.

However, practicalities limit the usefulness and appeal of tactile labeling. One method of providing extra information is to label elements the tactile diagram with Braille. However, Braille is approximately the size of 29 point type and a Braille label must be surrounded by a substantial planar area for the label to be tactilely perceptible. The size of a tactile diagram is limited by the user's ability to comfortably touch all parts of the diagram and, therefore, replacing a text label with a Braille label is often impractical when an image is complex or graphically rich. Enlarging a portion of the document to enable insertion of tactile labeling is often not practical because documents obtained from Internet are commonly raster images which deteriorate rapidly with magnification and, in the absence of tactile labeling, the user may not be able to determine if the document contains elements of interest or locate interesting elements in the graphical display. On the other hand, while tactile labeling can enhance the accessibility of electronic documents, reliance on Braille labeling restricts the usefulness of labeled documents to the group of visually impaired individuals that are competent Braille readers which is estimated to be only 10 to 20% of the legally blind population.

Furthermore, these devices and methods of providing accessibility to the visually impaired do not generally support interactivity, such as the ability to complete forms on the Internet and Worldwide Web. What is desired is an interactive audio-tactile system that overcomes the above-noted deficiencies and provides a high quality interactive computing experience for a visually impaired user.

### BRIEF DESCRIPTION OF THE DRAWINGS

FIG. 1 is a perspective view of an interactive audio-tactile computer system.

FIG. 2 is a block diagram of the interactive audio-tactile computer system of FIG. 1.

FIG. 3 is a perspective view of a tactile monitor

FIG. 4 is a perspective view of a Braille monitor.

FIG. 5 is a perspective view of a tactile mouse.

FIG. 6 is a facsimile of a portion of an exemplary tax form.

FIG. 7 is exemplary SVG source code for a portion of an electronic replica of the tax form of FIG. 6.

FIG. 8 is a block diagram of an SVG writer application program.

FIG. 9 is a flow diagram of the SVG document writing method of the SVG writer of FIG. 8

FIG. 10 is a block diagram of an access enabled browser of the interactive audio-tactile system.

FIG. 11A is a flow diagram of a first portion of a method of presenting SVG documents with the interactive audio-tactile system.

FIG. 11B is a flow diagram of a second portion of the method of presenting SVG documents illustrated in FIG. 11A.

FIG. 11C is a flow diagram of a third portion of the method of presenting SVG documents illustrated in FIG. 11A.

FIG. 11D is a flow diagram of a fourth portion of the method of presenting SVG documents illustrated in the flow diagram of FIG. 11A.

### DETAILED DESCRIPTION OF THE INVENTION

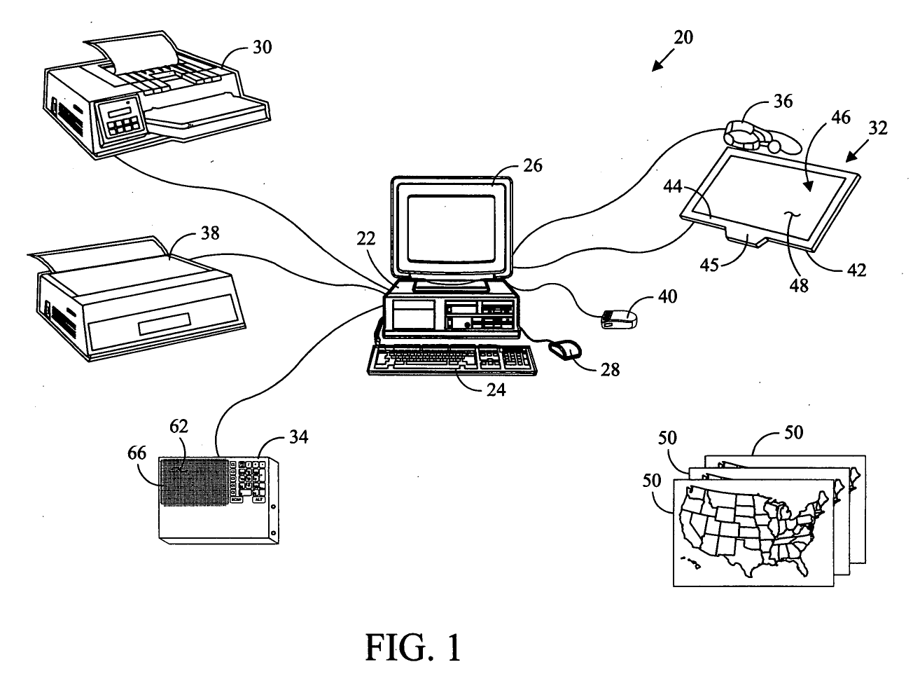

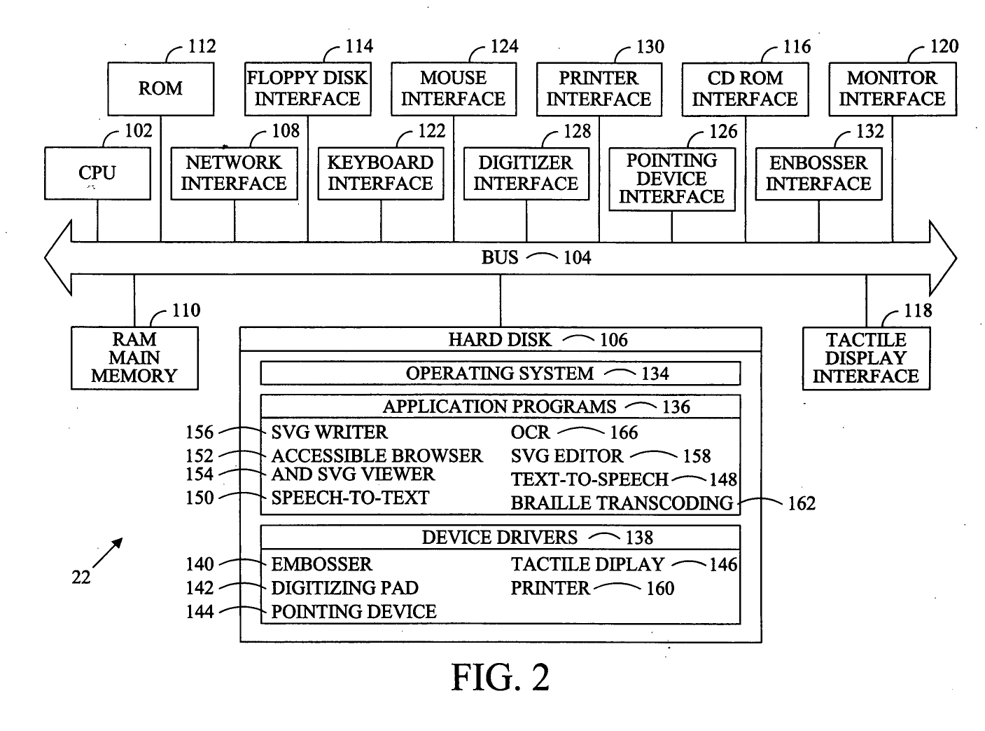

Interpretation, understanding, and interaction with web pages and other electronic documents comprising text and graphic elements are continuing problems for the visually impaired. Referring in detail to the drawings where similar parts of the invention are identified by like reference numerals, and, more particularly to FIGS. 1 and 2, the interactive audio-tactile system 20 provides an apparatus and method for presenting web pages and other documents to a visually impaired computer user. The interactive audio-tactile system 20 permits a visually impaired user to navigate between and within documents; presents documents, or portions of documents, in a fashion intelligible to a visually impaired user; and preserves the original document structure permitting the user to interact with the document.

The interactive audio-tactile system 20 comprises a host computer 22 that may include a number of devices common to personal computers, including a keyboard 24, a video monitor 26, a mouse 28, and a printer 30. Monitors and other display devices relying on visual perception may have limited utility to a visually impaired user but may be included in the audio-tactile system 20 because the visually impaired user may have limited eyesight or may, from time-to-time, interact with a sighted user through the audio-tactile system. In addition, the host computer 22 includes several peripheral devices that may be used in computer systems other than the audio-tactile system, but have specific utility to a visually impaired user. These peripheral devices may include a digitizing pad 32; a tactile monitor 34; audio output system, including headphones 36 or speakers; an embosser 38; and a haptic or tactile pointing device 40. The peripheral devices may be connected to the host computer 22 by cables connecting an interface of the peripheral device to a PC interface, for example, the host computer's USB (universal serial bus) port. On the other hand, a peripheral device may be connected to the host computer 22 by a known wireless communication link.

The digitizing pad 32 is communicatively connected to the host computer 22 of the interactive audio-tactile system 20. The exemplary digitizing pad 32 has a housing 42 and includes a frame 44 that is hinged to open and close relative to the housing. The frame 44 defines a rectangular shaped window 46 and has a handle section or outwardly extending tab 45 permitting the user to easily grip and lift the front of the frame for opening and closing. The digitizing pad 32 has a contact sensitive planar touch surface or touch pad 48. The touch pad 48 comprises an upper work surface that faces the frame 44 and is viewable through the window 46 when the frame is in a closed position, as illustrated in FIG. 1. A tactile diagram or overlay 50 can be disposed over the touch pad 48 by opening the frame 44 and then placing the tactile diagram on the touch pad before closing the frame. In the exemplary digitizing pad 32, closing the frame secures the tactile diagram 50 so it is restrained relative to the touch pad 48 but any number of known registering and fastening mechanisms can be used to position and secure the tactile diagram. For example, the tactile diagram could be aligned with edges of the digitizing pad, for instance, the top and left edges, for registration and then clamped along one edge so that the tactile diagram can extend beyond the edges of the digitizing pad permitting use of a tactile diagram that is larger than the digitizing pad.

The touch pad 48 is a contact sensitive planar surface and typically is in the form of a pressure sensitive touch screen. Touch screens have found widespread use in a variety of applications, including automated teller machines (ATMs) and other user interactive devices. Generally, the touch pad 48 includes a sensor array that produces an X-, Y-coordinate signal representing the coordinates of a contact with the surface of the touch pad. For example, resistive touch pads include a number of vertical and horizontal conductors (not shown) arrayed on a planar pressure sensitive surface. When the user exerts pressure on a region of the planar surface of the touch pad, particular conductors are displaced and make contact. A resistive touch pad typically includes a touch pad controller that determines the X- and Y-coordinates of the depressed region of the touch pad from the resistance of the various conductors in the array.

Capacitive touch pads compute the coordinates of a contact from relative changes in an electric field generated in the touch pad. Capacitive touch pads comprise multiple layers of glass with a thin patterned conductive film or wire mesh interposed between a pair of the layers. An oscillator, attached to each corner of the touch pad 40, induces a low voltage electrical field in the conductive film or mesh. When the glass surface is touched, the properties of the electric field change and the touch pad's controller computes the coordinates of the point of contact by measuring the relative changes of the electric field at a plurality of electrodes. Surface Acoustic Wave (SAW) touch pads comprise acoustic transceivers at three corners and reflectors arrayed along the edges of the touch pad area. The touch pad's controller calculates the coordinates of contact with the touch pad from the relative loss of energy in acoustic waves transmitted across the surface between the various transceivers. The controller for the touch pad 48 transmits the coordinates of a user contact to the host computer 22 permitting the user to designate points of interest on the tactile diagram 50.

Tactile diagrams 50 are commercially available from a number of sources. In one embodiment, the tactile diagram 50 is pre-embossed on a vacuum-thermoformed PVC sheet. Tactile diagrams 50 can also produced by an embosser 38 controlled by the host computer 22. The exemplary embosser 38 is similar in construction and operation to a dot matrix printer. A plurality movable embossing tools are contained in an embossing head that moves across a workpiece supported by a platen. The tools selectively impact the workpiece as the embossing head moves and the impacts of the embossing tool impress raised areas, such as dots and vertical or horizontal line segments in the workpiece. These raised areas can be impressed on Braille paper, plastic sheets, or any other medium that can be deformed by the embossing tools and which will hold its shape after deformation. The raised areas can form Braille symbols, alphanumeric symbols, or graphical elements, such as maps or charts. The embosser 38 is controlled by a device driver that is similar to the program used to control a dot matrix printer. A printer head may also be attached to the embossing head so that a graphic images, bar codes, or text, may be printed on the embossed tactile diagram 50 to facilitate identification of the tactile diagram or registering the position of the tactile diagram relative to the touch pad 48.

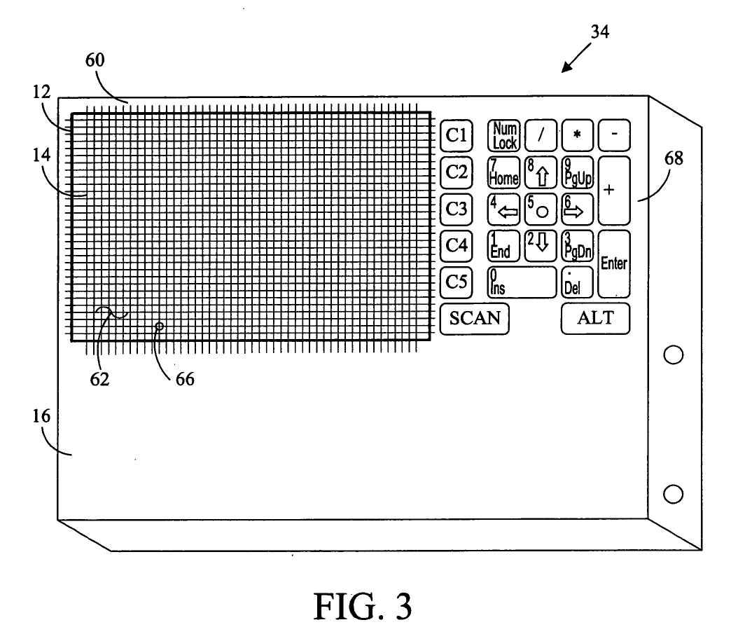

In addition to a video monitor 26, the host computer 22 of the exemplary interactive audio-tactile system 20 includes a tactile monitor 34. The tactile monitor 34 includes a housing 60 that supports a tactile surface 62. The tactile surface 62 includes a plurality of selectively protrusible surfaces 66. Typically the protrusible surfaces 66 comprise the ends of movable pins arranged in holes in the tactile surface 62. The pins are typically selectively driven by piezoelectric or electromechanical drivers to selectively project above the tactile surface 62. By moving fingers over the tactile surface 62, a visually impaired user of the tactile monitor 34 can identify tactile representations formed by the selectively protruding pins. As illustrated in FIG. 3, the protrusible surfaces 66 may be distributed in a substantially uniform array permitting the tactile monitor 34 to display tactile representations of graphic elements, as well as Braille symbols. The tactile monitor 34 may also include a key pad 68 or other input device.

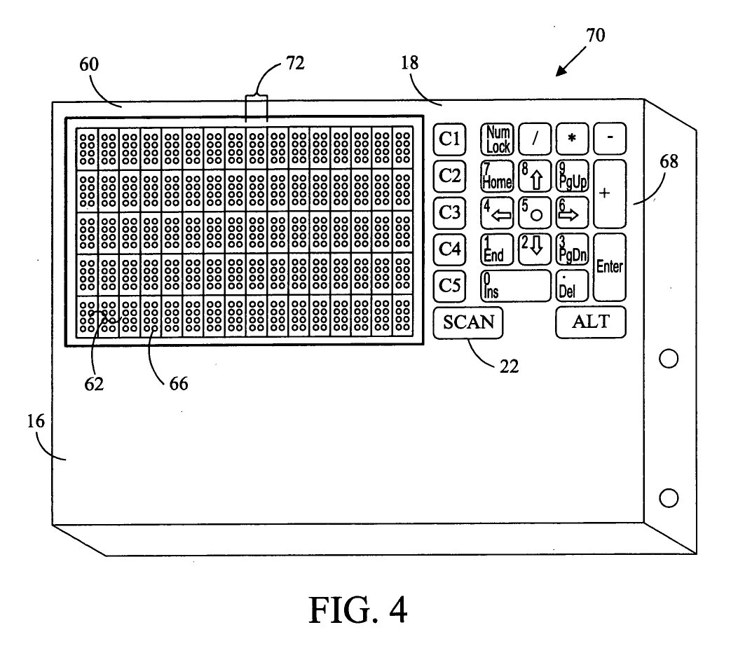

An alternative embodiment of the tactile monitor 34 is the Braille monitor 70 illustrated in FIG. 4. The Braille monitor 70 is specially adapted to produce the tactile symbols of the Braille system. The protrusible surfaces 66 of the Braille monitor 70 are arranged in rows and columns of rectangular cells 72 (indicated by a bracket). Each cell includes three or, as illustrated, four rows and two columns of protrusible surfaces 66. Selective projection of the protrusible surfaces 66 can create lines of the six-dot tactile cells of the standard Braille format or an eight-dot cell of an expanded 256 symbol Braille format.

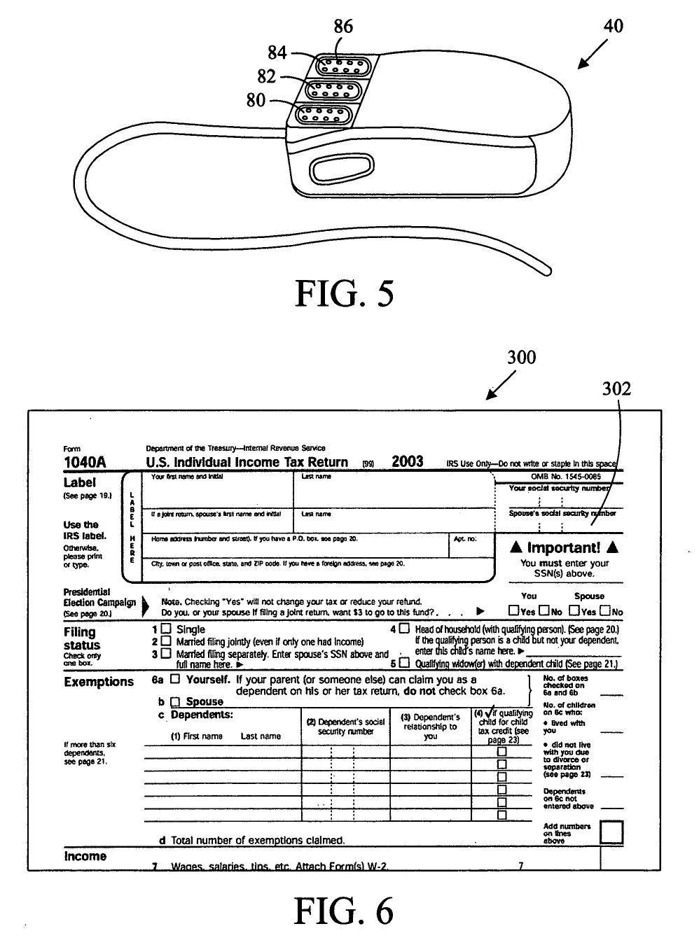

The interactive audio-tactile system 20 typically includes at least one pointing device. The pointing device may be a standard computer mouse 28. However, the interactive audio-tactile system 20 may include a specialized tactile or haptic pointing device 40 in place of or in addition to a mouse. For example, referring to FIG. 5, a tactile pointing device 40 may include a plurality of tactile arrays 80, 82, 84 each including a plurality of protrusible surfaces 86. During use, the user rests a finger on each of the tactile arrays and as the tactile mouse 40 is moved the textures of individual arrays are changed allowing the user to feel outlines of icons or other symbols generated by the host computer 22 in response to the position and state of the cursor or display pointer. The pointing device may also incorporate haptic feedback, for example, providing an increasing or decreasing force resisting movement of the pointing device toward or away from a location in a document or menu.

FIG. 2 is a block diagram showing the internal architecture of the host computer 22. The host computer 22 includes a central processing unit (“CPU”) 102 that interfaces with a bus 104. Also interfacing with the bus 104 are a hard disk drive 106 for storing programs and data, a network interface 108 for network access, random access memory (“RAM”) 110 for use as main memory, read only memory (“ROM”) 112, a floppy disk drive interface 114, and a CD ROM interface 116. The various input and output devices of the interactive audio-tactile system 20 communicate with the bus 104 through respective interfaces including, a tactile display interface 118, a monitor interface 120, a keyboard interface 122, a mouse interface 124, a tactile or haptic pointing device interface 126, a digitizing pad interface 128, a printer interface 130, and an embosser interface 132.

Main memory 110 interfaces with the bus 104 to provide RAM storage for the CPU 102 during execution of software programs; such as, the operating system 132, application programs 136, and device drivers 138. More specifically, the CPU 102 loads computer-executable process steps from the hard disk 106 or other memory media into a region of main memory 110, and thereafter executes the stored process steps from the main memory 110 in order to execute software programs. The software programs used by the interactive audio-tactile system 20 include a plurality of device drivers 138, such as an embosser driver 140, a pointing device driver 144, a tactile display driver 146, and a digitizing pad driver 142 to communicate with and control the operation of the various peripheral devices of the interactive audio-tactile system.

The host computer 22 of the interactive audio-tactile system 20 may include a number of application programs 136 for acquiring, manipulating, and presenting electronic documents to the user. The application programs 136 may include standard office productivity programs, such as word processing and spread sheet programs or office productivity programs that have been modified or customized to enhance accessibility by a visually impaired user. For example, a word processing program may include speech-to-text or text-to-speech features or interact with separate text-to-speech 148 and speech-to-text 150 applications to facilitate the visually impaired user's navigation of graphical menus with oral commands or convert oral dictation to text input. In addition, the application programs of the interactive audio-tactile system 20 may include specialized programs to aid a visually impaired user. For example, the application programs of the interactive audio-tactile system 20 include an access enabled browser 152 including an SVG viewer 154 that reads SVG data files and presents them to the user. To enable authoring of SVG files, the application programs of the interactive audio-tactile system 20 include an SVG writer 156 and SVG editor 156 to convert non-SVG files to SVG files and to modify SVG files, including modifications to enhance access.

SVG (Scalable Vector Graphics); SCALABLE VECTOR GRAPHICS (SVG) 1.1 SPECIFICATION, http://www.w3.org/TR/2003/REC-SVG11-20030114, incorporated herein by reference, is a platform for two-dimensional graphics. SVG also supports animation and scripting languages such as ECMAScript, a standardized version of the JavaScript language; ECMA SCRIPT LANGUAGE SPECIFICATION, ECMA-262, Edition 3, European Computer Manufacturer's Association. SVG is an application of XML; EXTENSIBLE MARKUP LANGUAGE (XML), 1.0 (Third Edition), W3C Recommendation, 04 February 2004, http://www.w3.org/TR/2004/REC-xml-20040204, and comprises an XML based file format and an application programming interface (API) for graphical applications. Electronic documents incorporating SVG elements (SVG documents) can include images, vector graphic shapes, and text that can be mixed with other XML based languages in a hybrid XML document.

The vector graphic objects of an SVG document are scalable to different display resolutions permitting a graphic to be displayed at the same size on screens of differing resolutions and printed using the full resolution of a particular printer. Likewise, the same SVG graphic can be placed at different sizes on the same Web page, and re-used at different sizes on different pages. An SVG graphic can also be magnified or zoomed without distorting the vector graphic elements to display finer details included in the document. SVG content can be a stand-alone graphic, content included inside another SVG graphic, or content referenced by another SVG graphic permitting complex illustrations to be built up in parts and rendered at differing scales.

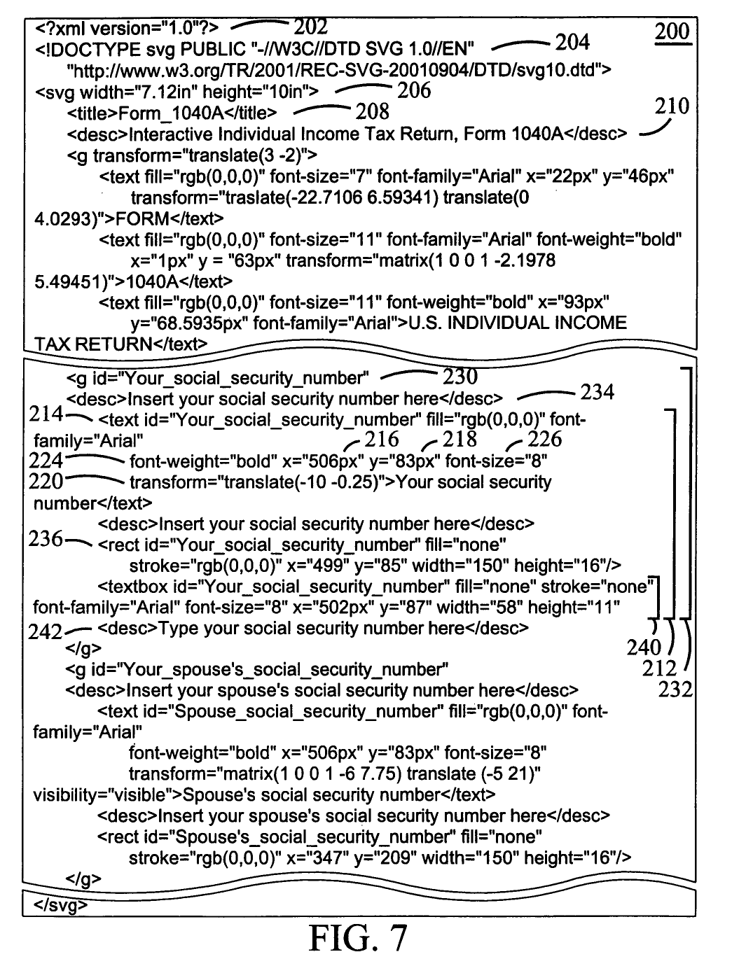

An SVG document comprises markup and content and can be a stand alone web page that is loaded directly into an SVG viewer 154 equipped browser or an SVG document can be stored separately and embedded in a parent web page where it is specified by reference. SVG documents include a plurality of objects or elements, each defined by a plurality of attributes. For example, FIG. 7 illustrates SVG source code 200 for a portion of an SVG document replicating a portion of an exemplary tax form 300, illustrated in part in FIG. 6. The form 300 is available in editable format on the Worldwide Web and is an example of developing electronic commercial activity. In the editable format, a computer user can enter data at appropriate places in the form 300 and print or save the completed form. However, completing the form 300 and other similar activities are difficult for a visually impaired user because the unassisted user cannot read the instructions and has great difficulty locating, identifying, and interacting with the data entry points in the form. The interactive audio-tactile system 20 enables interactivity between electronic documents and users with impaired vision.

The exemplary SVG document source code 200 begins with a standard XML processing instruction 202 and a document type (DOCTYPE) declaration 204 that identify the version of XML to which the document is authored and that the document fragment is an SVG document fragment. The root element (<svg>) 204 is a container element for the subsequent SVG elements and defines the overall width and height of the graphic. The title (<title>) 208 and description (<desc>) 210 attributes provide, respectively, a title for the document to be used in a title bar by the viewing program and an opportunity to describe the document. The SVG document 200 also includes a text object 212 (indicated by a bracket) defining the content, location, and other characteristics of text to be displayed on the form indicating where the taxpayer's social security number 302 should be entered in the form. The attributes of the SVG object include an object id 214 identifying the object by type and name. The attributes also include an x-coordinate position attribute 216 and a y-coordinate position attribute 218 locating the object in the document. An SVG text object, such as the object YOUR SOCIAL SECURITY NUMBER 212, is a container object that includes the text that will be rendered at the object's location. The attributes of the text object 212 also include the font family 222, weight 224, and size 226. In the case of graphic shapes; for example, the rectangle YOUR SOCIAL SECURITY NUMBER 236, the object attributes typically include an identification of the primitive shape, such as a rectangle or circle, the specific object, the location of the object, and its size.

SVG permits objects included in the document to be associated. A grouping element 230 defines a container 232 (indicated by a bracket) for a plurality of objects or a plurality of groups of objects that can be given a group name and group description 234. SVG graphics can be interactive and responsive to user initiated events. Enclosing an object in a linking element causes the element to become active and when selected; for example, by clicking a button of the pointing device, to link to a uniform resource locator specified in an attribute of the linking element. Further, a program in ECMAScript can respond to events associated with an SVG object. User initiated events, such as depressing a button on a pointing device, moving the display pointer to a location corresponding to an displayed object or away from a location of a displayed object, changing the status of an object, and events associated with pressing keys can cause scripts to execute initiating animation or actions relative to objects in the SVG document.

SVG also incorporates the Document Object Model (DOM), an application programming interface that defines the logical structure of a document and the way the document can be accessed and manipulated. In the DOM, documents have a logical structure that resembles a tree in which the document is modeled using objects and the model describes not only the structure of the document but also the behavior of the document and the objects of which it is composed. The DOM identifies the interfaces and objects used to represent and manipulate a document; the semantics of these interfaces and objects, including behavior and attributes; and the relationships and collaboration among the interfaces and objects. The DOM permits navigation through the document's structure and addition, modification, and deletion of document elements and content.

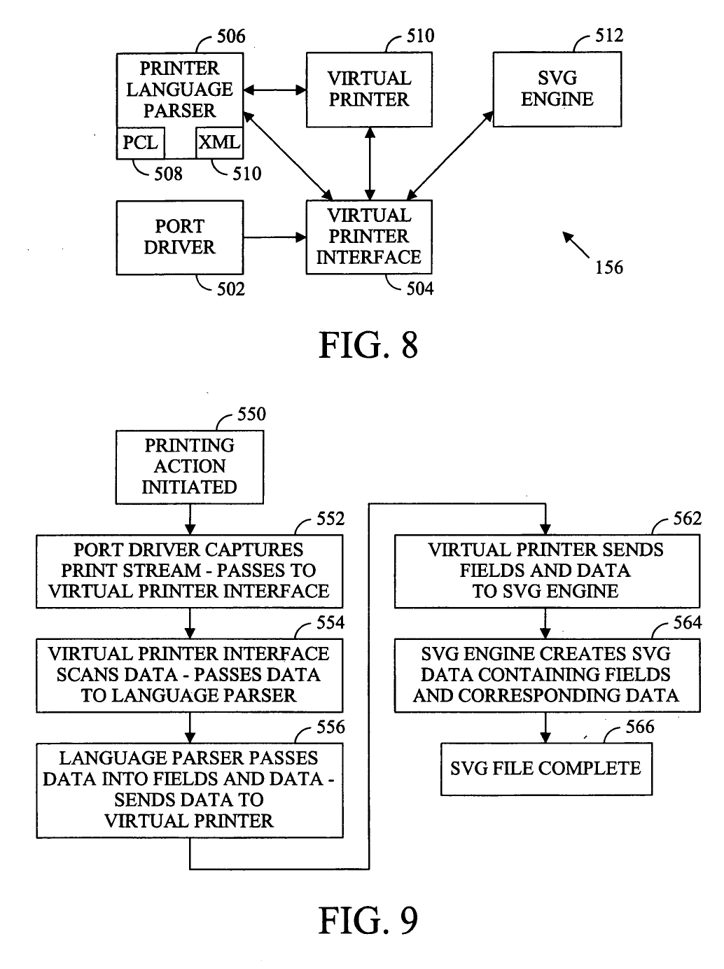

The SVG writer 156 of the interactive audio-tactile system 20 converts electronic documents in formats other than SVG into SVG formatted documents. Referring to FIGS. 8 and 9, the SVG writer 156 for the interactive audio-tactile system 20 is preferably implemented in connection with a printer driver 116 or an embosser driver 140, but may be implemented as a stand-alone software application program. Document conversion starts when the user selects the SVG writer 156 as the printer for an electronic document and initiates a print action with the interactive audio-tactile system 20. At step 552, a port driver 502 captures the print stream data flowing from the printer port of the host computer 22 and passes the data to a virtual printer interface 504. The virtual printer interface 504 scans the data to determine the language of the print stream and loads a printer language parser 506 corresponding to the print stream language 554.

The printer language parser 506 receives the print stream data and converts it to an interpreted set of fields and data 556. Printer language parsers may include, but are not limited to, a PCL language parser 508 and an XML language parser 510. The printer language parser 506 loads the parsed data stream into a virtual printer 510 that reconstitutes the data as a collection of fields; for example, names and corresponding values, and logical groupings of fields (e.g., packets), physically described by a printer language or markup.

At step 556, the virtual printer 510 outputs the reconstituted data to an SVG engine 512 that scans the data, recognizes the logical groupings of data, and breaks groupings into fields. The SVG engine 512 recognizes and extracts fields and corresponding data from the raw data and marks up the fields and data according to the SVG format 560. The SVG engine 512 outputs an SVG conversion file 562 containing SVG data fields that includes the corresponding data.

To enhance the capability of an SVG document; for example, the SVG document 200, the SVG engine 512 can insert a textbox object 240 into the SVG file. A textbox 240 is an object that permits a user to insert text or edit text at a location in the SVG file. The textbox 240 is an area located within the YOUR SOCIAL SECURITY rectangle 236 as specified by the x- and y-position attributes of the textbox. When the display pointer is placed within the area defined for the textbox 240, the user can select the textbox by operation of a mouse button, enter key, or key pad element. By depressing a combination of keys, the user can then insert or otherwise edit text included in the textbox. The user can insert a social security number in the textbox 240 that will be displayed or can be saved for display in the document 200 at the position of the textbox as defined by its attributes. To insert a textbox, such as textbox 240, into the file the SVG writer 156 query's the DOM of the conversion file for objects making up the document and inserts the SVG textbox 564 at a location designated by the user to produce the competed SVG file 566.

To enhance the accessibility of SVG documents, the interactive audio-tactile system also includes an SVG editor 158. An SVG file contains text and can be edited with a text editor or a graphically based editor. Since SVG incorporates the DOM, the editor 158 graphically presents the DOM to the user facilitating browsing of the document structure and locating objects included in the document. The SVG editor 158 of the interactive tactile system 20 permits selection, grouping, associating, and labeling of objects contained in an SVG document. For example, since Braille symbols are commonly much larger than text and must be isolated from other tactile features to be tactilely perceptible, it is not feasible to directly replace text labels with Braille in many situations. The SVG editor 156 permits an area of a document to be selected and designated as a receptacle object that can contain one or more associated objects and which is typically not visible in the displayed document. The receptacle may be an area larger than that occupied by the object or objects that it contains. The receptacle can be used to define an area in which a Braille label can be rendered without adversely affecting the other objects of the document. If a text label is sufficiently isolated from other objects of the document, it can be replaced by a Braille label as long as the Braille label is smaller than the boundaries established by the receptacle.

In addition, the SVG editor 156 permits the user to label an object or group of objects with a text description that can be output to the text to speech application 148 and a Braille transcoding application 162 to convert the text to Braille for display on the tactile display 34. An event, initiated, for example, by movement of the display pointer, can cause the description of an object to be output aurally by the system or tactilely displayed on the tactile display 34. The SVG editor 158 can also invoke the SVG writer 156 to insert a textbox 564 into an SVG file.

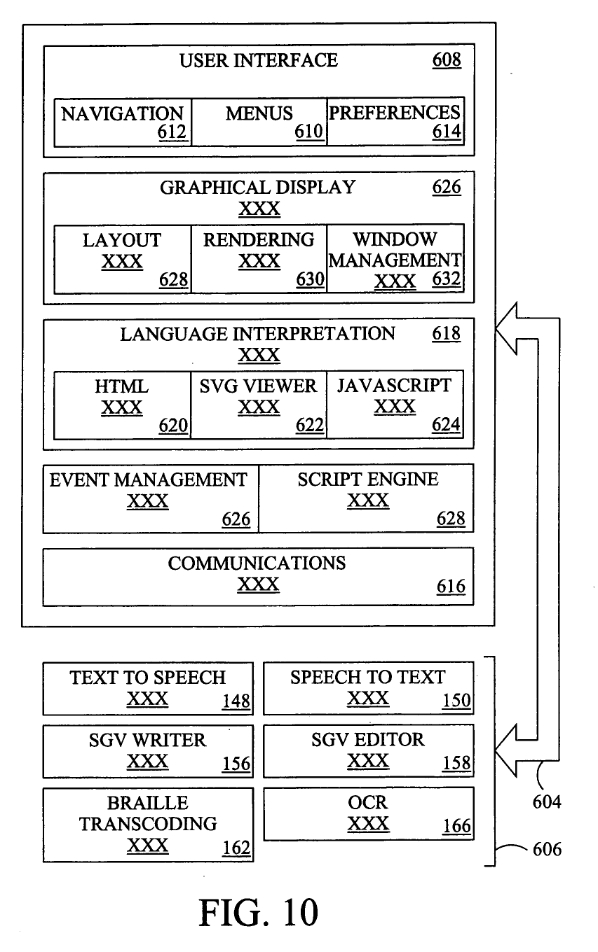

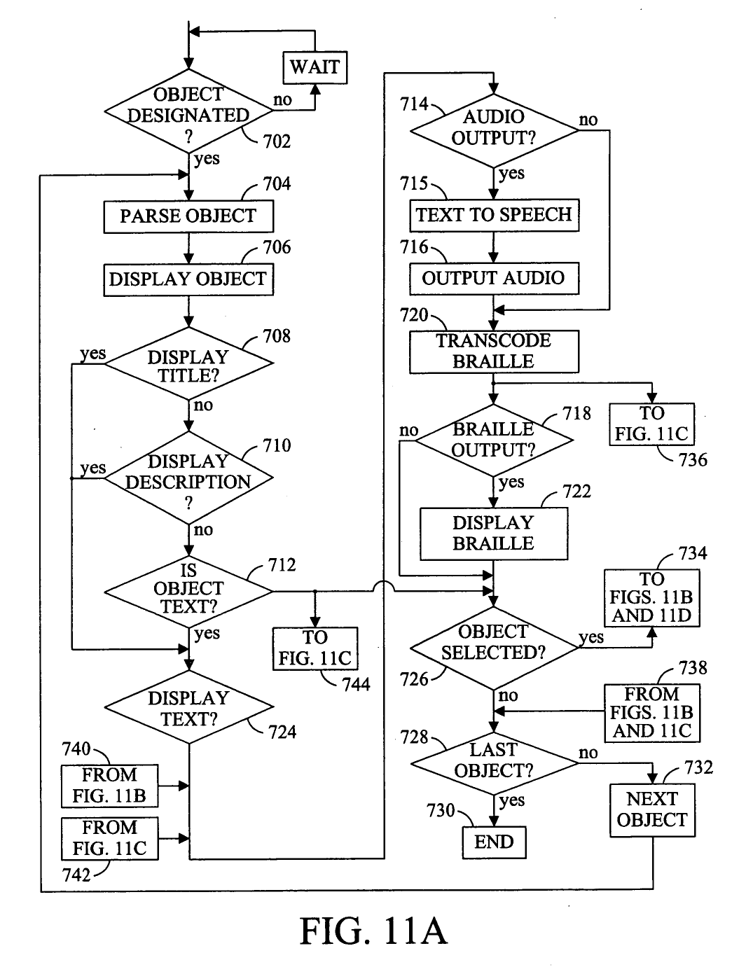

A block diagram of an access enabled browser program 164 depicted in FIG. 10. A browser is an application program used to navigate or view information or data that is usually contained in a distributed database, such as the Internet or the World Wide Web. The access enabled browser 164 is presented as an exemplary browser program 600 in communication 604 with a plurality of other application programs (indicated by a bracket) 606 useful in facilitating accessibility of electronic documents obtained by the browser. FIG. 10 presents an embodiment of the access enabled browser 164, but is not meant to imply architectural limitations to the present invention. For example, the access enabled browser 164 may be implemented using a known browser application, such Microsoft® Internet Explorer, available from Microsoft Corporation and may include additional functions not shown or may omit functions shown in the access enabled browser. Likewise, while the exemplary access enabled browser 164 includes a browser 600 in communication 604 with a plurality of application programs 606 (indicated by a bracket), one or more of the application programs could be combined or incorporated into the browser 600.

The exemplary access enabled browser 164 includes an enhanced user interface (UI) 608 that facilitates user communication with the browser 600. This interface enables selecting various functions through menus 610. For example, a menu 610 may enable a user to perform various functions, such as saving a file, opening a new window, displaying a history, and entering a URL. The user can also select accessibility options such as audio and Braille presentation of names of menus and functions, document object descriptions, and text. The browser 600 communicates with a text-to-speech application 148 that converts textual titles for menus and functions to audio signals for presentation to the user over a headphone 36 or a speaker driven by the host computer 22. The browser 600 also communicates with a speech to text application 150 permitting the user to orally input commands to the browser.

The browser 600 communicates with a Braille transcoding application 162 that can output a Braille symbol to a tactile pointing device 40, a tactile display 30, or to the driver of an embosser 38. The Braille transcoding application 162 can provide a tactile indication of menu options available on the user interface 608. The visually impaired user may receive audible or tactile indications of available menu and functions either as the display pointer is moved over the visual display, as the browser “reads” through the structure of menu choices, or in response to a keyboard input or some other action of the user or host computer 22.

The navigation unit 612 permits a user to navigate various pages and to select web sites for viewing. For example, the navigation unit 612 may allow a user to select a previous page or a page subsequent to the present page for display. Specific user preferences may be set through a preferences unit 614.

The communication manager 616 is the mechanism with which the browser 600 receives documents and other resources from a network such as the Internet. In addition, the communication manager 616 is used to send or upload documents and resources onto a network. In the exemplary access enabled browser 164, the communication manager 616 uses HTTP, but other communication protocols may be used depending on the implementation.

Documents that are received by the access enabled browser 164 are processed by a language interpreter 618 that identifies and parses the language used in the document. The exemplary language interpreter 618 includes an HTML unit 620, a scaled vector graphics (SVG) unit 622, and a JavaScript unit 624 that can process ECMAScript for processing documents that include statements in the respective languages, but can include parsers for other languages as well. The language interpreter 618 processes a document for presentation by the graphical display unit 626. The graphical display unit 624 includes a layout unit 628 that identifies objects and other elements comprising a page of an electronic document and determines the position of the objects when rendered on the user interface 608 by the rendering unit 630. Hypertext Markup Language (HTML) supports the division of the browser display area into a plurality of independent windows or frames, each displaying a different web page. The dimensions and other attributes of the windows are controlled a window management unit 632. The graphical display 626, presents web pages to a user based on the output of the language interpreter 618.

The layout unit 628 also determines if a displayed web page specifies an event in association with an object in a document being displayed by the access enabled browser 164. An event is an action or occurrence that is generated by the browser 600 in response to an input to produce an effect on an associated object. Events can be initiated by user action, such as movement of the cursor or pointing device, depression of a button on the pointing device or mouse, an input to a digitizing pad, or by an occurrence in the system, such as running short of memory. An association between an event and an action can be established by a script language, such as JavaScript and ECMAScript, a browser plug-in, a programming language, such as Java or Active X; or by a combination of these tools. For example, the JavaScript event attribute ONMOUSEOVER can be used to initiate an action manipulating an object when the cursor or display pointer is moved to a location in the displayed document specified in the attribute. Events associated with objects comprising the displayed document are registered with the event management unit 626. When the user interface 608 detects an input related to an object, the input is transferred to the graphical display unit 626 to generate an event and identify the associated object and the frame in which the object is located. The event management unit 626 determines if action is required by determining if the event is registered for the detected object. If the event is registered, the event management unit 626 causes the script engine 628 to execute the script implementing the action associated with the event.

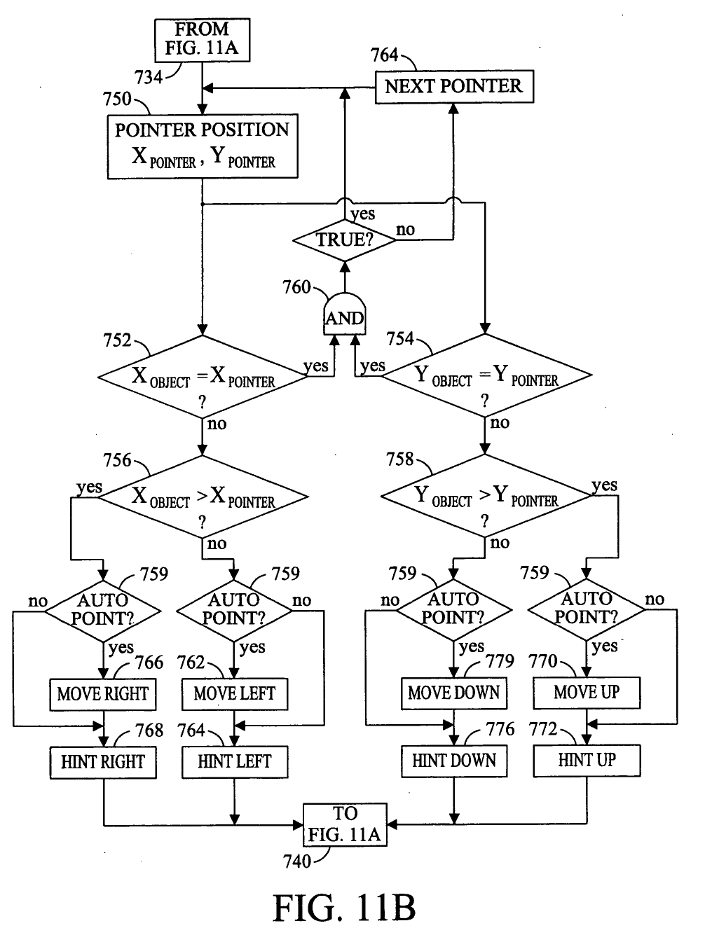

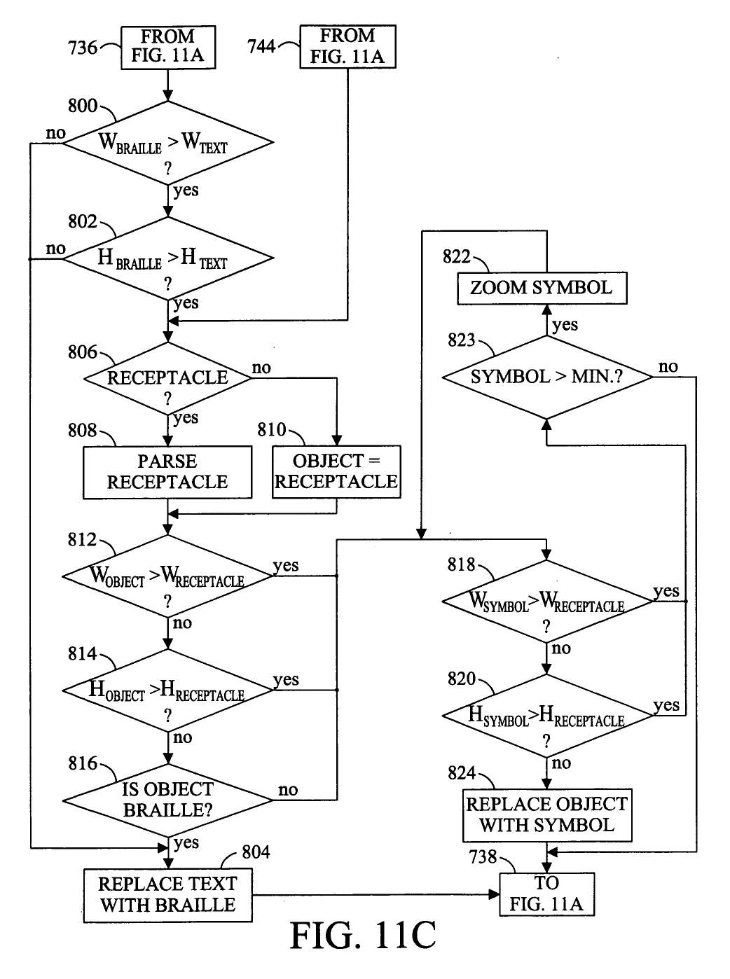

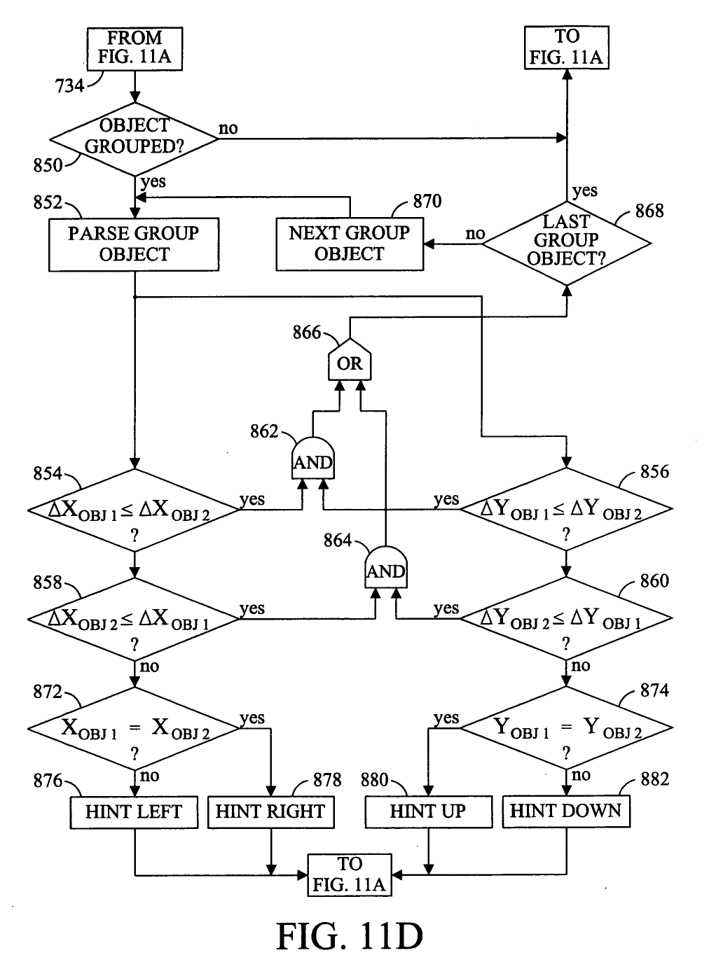

The SVG viewer 622 of the access enabled browser 164 enhances accessibility of SVG encoded electronic documents through a method that enables audible and tactile description of document elements, improves tactile labeling of objects of tactile diagrams, and facilitates locating objects of interest in a displayed document. Referring to FIGS. 11A-11D, the method 700 is initiated when the user selects on or more objects of interest 702. The user can select all of the objects contained in a document by depressing a button on a mouse 28 or a haptic pointing device 40 or by inputting an oral command to the browser 164 through the speech-to-text application 150. On the other hand, the user can select all of the objects in the document or the objects included in an area within the document by selecting a corresponding area of a tactile diagram 50 on the digitizing pad 32. The user may also select individual objects by moving the display pointer over the displayed document or by browsing the DOM for the document. The browser 600 sequentially parses the designated objects 704 and, if not already displayed, the interactive audio-tactile system 20 displays the objects on the monitor 26. To reduce the quantity of audio and tactile output by the browser, the user can elect to have only certain types of fields audibly or tactilely displayed. For example, to speed the completion of online forms, the user might choose to have only textbox objects audibly or tactilely processed by the browser. If the user has requested that the system display the titles of objects 708, the system determines if audio output of the title has been selected by the user 714. If audio output has been requested, the text of the object's title is passed to the text-to-speech unit 715 and the title is audibly presented to the user 716. The title of the object will be transcoded to Braille 718 and displayed on the tactile display 722, if the user has requested Braille output 718.

Even if the title of the object is not to be displayed 706, the system 20 will determine if the description of object 234, 242 included in a description attribute is to be displayed 710. If the description is to be displayed 710, the system 20 will aurally 716 and tactilely 722 present the description following the method described above for presentation of the title.

The system 20 will also audibly 716 and tactilely 722 display the text contained in text objects 712 if the user as elected one or both of these display options of the text 724. For example, if a user selects the tax form 300; the access enhanced browser 164 will sequentially announce the title, description and text content of objects and groups or associations of objects contained in the form. When the user hears or tactilely detects YOUR SOCIAL SECURITY NUMBER, the user can select the object by interaction, such as depressing a mouse button or issuing an oral command to the speech-to-text application 150. If an object is not selected 726, the method determines if the last object in the designated area has been processed 728. If all of the objects designated by the user have been processed, the program terminates 730. If not, the system processes the next object 732.

Visually impaired users may have difficulty locating an object of interest in a document, even if the document is presented in tactile form. Further, the visually impaired user may have difficulty initially locating the position of the cursor or display pointer relative to the document and then, unless the user has knowledge of the spatial relationships of the objects in the document, knowing which way to move the pointer to reach the point of interest. For example, in the tax form 300, a user interested in entering his or her's social security number may have difficulty finding the appropriate point in the form 302, even if the cursor is initially at a known position in the document.

The access enabled browser 164 of the interactive audio-tactile system 20 facilitates locating objects in an SVG electronic document. If the user selects an object when its presence is audibly or tactilely announced 726, 734, the browser 600 determines the current position of the display pointer 750 and compares the position (x- and y-coordinates) of the pointer to the position of the selected object as specified in the object's attributes. If the respective x-752 and y-754 coordinates of the pointer are co-located with object 760, the pointer remains at the object. If the pointer is not already located at the selected object 752, 754, the system determines the direction and distance that the pointer must move 756, 757 to become coincident with the object. The user can elect to have pointer moved automatically to the current object 759. If the pointer is to the right of the object, the pointer will be moved to the left 762 and, if to the left of the object, the pointer will be moved to the right 766. Similarly, if the pointer and the object are not co-located vertically 758, the direction and distance that the pointer must be moved vertically is determined and the pointer is moved to the object 770, 774. As a result, the cursor or display pointer will follow the parsing of objects in the web page. If the user elects to maintain control of pointer movement 759, the system will 740 audibly 716 or tactilely 722 present hints to the user concerning the direction and distance to move the pointer from its current position to the location of the selected object 764, 768, 772, 774. The system periodically determines the current position of the display pointer 764 and will move the display pointer or provide hints for moving the pointer until it is co-located with the selected object 752, 754.

In some cases, related objects in an SVG document may be physically separated from each other. For example, a first portion of text may be included in a first object that is physically separated by a graphic object from the remainder of the text in a second object. While sighted persons can, generally, locate related, but physically separated, objects, it is very difficult for a visually impaired user to do so. The access enabled browser 164 provides hints to the user to assist the user in locating related and physically separated objects. SVG provides for grouping of elements included in a document. Referring particularly to FIGS. 11A and 11D, when the user of the access enabled browser 164 selects an object 726, the browser determines if the object is a member of a group of objects 850. If the selected object is a member of a group 850, the browser parses the next object in the group 852. If the next group object is co-located with the first object, that is either the width and the height 862 of the first object is within the bounds of the second object 854, 856 or 866 or the width and height 864 is the second object is within the bounds of the first object 858, 860, the method processes the next grouped object 870 until all of the objects have been processed 868. On the other hand, if two grouped objects are not collocated 854, 856, 858, 860; the access enabled browser 164 determines the horizontal 872 and vertical 874 direction and distance from the first object to the second and hints to the user through the text-to-speech application 148 or the tactile display whether and how far the second object is located to the left 876, right 878, below 880 or above 882 the first object.

One method of accessing electronic documents is to create a tactile diagram 50 of the document and use the tactile diagram in conjunction with a digitizing pad 32 to locate and select objects of interest. However, the size of a digitizing pad is limited by the convenient reach of the user. While digitizing pads with heights or widths up to 18 inches are available, more commonly, digitizing pads are approximately 12 inches square. Standard Braille paper that is often used in embossing tactile diagrams is 11 inches wide. While an 11×12 inch map of the world may be of sufficient size to tactilely locate Europe, it is unlikely that the scale is sufficient to permit a visually impaired user to also tactilely locate Switzerland. Further, it is often difficult for a visually impaired person to make sense of tactile shapes and textures without some additional information to confirm or augment the graphical presentation. While Braille can be used to label tactile diagrams Braille symbols are large, an eight dot Braille cell is approximately 8.4 mm (0.33 in.) high×3.1 mm (0.12 in.) wide, and Braille symbols must be surrounded by a substantial planar area to be tactilely perceptible. A Braille label is, typically, substantially larger than a corresponding text label and direct replacement of text labels with Braille is often not possible. While the access enabled browser 164 includes a text-to-speech application 148 to audibly present text label objects contained in an SVG document to the user, a visually impaired user may still have difficulty locating areas of interest in a tactile diagram 50, particularly in documents that are rich in objects. The access enabled browser 164 includes a method of enhancing tactile diagrams 50 to facilitate the interaction of a visually impaired user with the document.

The access enabled browser 164 of the interactive audio-tactile system 20 enhances the accessibility of SVG electronic documents by providing for insertion of a symbol into a tactile diagram if an area of the document is too small to permit included objects or text to be presented tactilely. For example, the tax form 300 includes text labels in 6 or 7 point type but the large area required for Braille symbols would mean that the tactile symbols would overflow into other objects in the document or be too close to other tactile features to permit the user to tactilely perceive the Braille label if the text labels were replaced by Braille. If the size of the document was increased sufficiently to simply replace the text with an equivalent set of Braille symbols, the resulting tactile document would be so large that it could not be produced on the embosser 38 or used on the digitizing pad 32.

Referring to FIGS. 11A-11C, the access enabled browser 164 determines if the object is a text object 712. If the object is a text object 712, the object is transcoded to a Braille object 720 by the Braille transcoding application 162. The access enabled browser 164 then examines the attributes of the original text object and the Braille object to determine if the Braille object is wider 800 or higher 802 than the corresponding text. If the Braille object is no larger than the text object 800, 802, the text is replaced by Braille 804 and the browser moves to the next object 738.

However, if the parsed object is not a text object 712 or if the transcoded Braille object is larger than the corresponding text object 800, 802, the access enabled browser 164 determines if the parsed object is contained within another object 806. For examples, a text label may be included in a box in a form or a text object may be surrounded by a substantial blank area permitting the author of the document to associate an area of the document as a receptacle for the text object. This permits the author of the document to authorize the conversion of text into much larger Braille symbols without infringing on the boundaries of other objects in the document. If no receptacle has been specified for the object 806, the object is specified as its own receptacle 810. If another object has been associated with the parsed object as a receptacle 806, the receptacle object is parsed 808 and the width and height of the object are compared to the specified width and height of the receptacle 812, 814. If the receptacle is larger than the object and if the object is a Braille object 816, the text is replaced by the equivalent Braille symbols 804. If the object is larger than the receptacle 812, 814, or if the object is not a Braille object 816, the browser 164 determines if a symbol object, that will indicate to the user that the corresponding area of the tactile document contains text or other objects that cannot be rendered at the current resolution of the document, can be inserted in the receptacle 818, 808. The browser 164 compares the size of the symbol object to the size of the receptacle object 820, 818 and alters the size of the SVG symbol object 822 if the symbol is greater than a minimum size 823 and too large to fit within the receptacle. When an object has been replaced by Braille 804 or a symbol 824, the program parses the next object 732 until it has parsed all the selected objects 728 and terminates 730. When the all of the selected objects have been parsed, the document can be embossed as a tactile diagram 50 for use with the digitizing pad 32. A visually impaired user can tactilely locate areas of interest in the tactile diagram even if tactile labeling is not feasible. The user can select an area containing the tactile symbol indicating the presence of objects that can not be rendered at the tactile diagram's current scale by depressing points on the tactile diagram bounding the area of interest. If the selected area contains a tactile symbol indicating that the area includes information that cannot be tactilely displayed at the current resolution of the document, the host computer 22 can zoom the vector graphical objects in the area to provide sufficient resolution to permit displaying the hidden objects and the related Braille labeling.

The interactive audio-tactile system 20 provides a computer user with impaired vision with a combination of aural and tactile cues and tools facilitating the users understanding and interaction with electronic documents displayed by the computer.

The detailed description, above, sets forth numerous specific details to provide a thorough understanding of the present invention. However, those skilled in the art will appreciate that the present invention may be practiced without these specific details. In other instances, well known methods, procedures, components, and circuitry have not been described in detail to avoid obscuring the present invention.

All the references cited herein are incorporated by reference.

The terms and expressions that have been employed in the foregoing specification are used as terms of description and not of limitation, and there is no intention, in the use of such terms and expressions, of excluding equivalents of the features shown and described or portions thereof, it being recognized that the scope of the invention is defined and limited only by the claims that follow.

1. A method of presenting an electronic document to a computer user, said electronic document comprising a scalable vector object including at least one attribute, said method comprising the steps of:
(a) parsing an attribute of said scalable vector object;
(b) converting said parsed attribute to an audio signal; and
(c) acoustically manifesting said audio signal.

2. The method of presenting an electronic document of claim 1 wherein said parsed attribute of said scalable vector object comprises a name of said object.

3. The method of presenting an electronic document of claim 1 wherein said parsed attribute of said scalable vector object comprises a description of said object.

4. The method of presenting an electronic document of claim 1 wherein said parsed attribute of said scalable vector object comprises a text attribute of said object.

5. The method of presenting an electronic document of claim 1 wherein said step of converting said parsed attribute to an audio signal comprises the step of selecting an audio file corresponding to said parsed attribute, said audio file comprising a prerecorded audio signal.

6. The method of presenting an electronic document of claim 1 wherein said step of converting said parsed attribute to an audio signal comprises the step of causing an audio signal corresponding to a text of said parsed attribute to be synthesized.

7. The method of presenting an electronic document of claim 1 further comprising the steps of:
(a) converting said parsed attribute to at least one tactile symbol; and
(b) causing presentation of at least one tactile symbol to said computer user.

8. The method of presenting an electronic document of claim 7 wherein said parsed attribute of said scalable vector object comprises a name of said object.

9. The method of presenting an electronic document of claim 7 wherein said parsed attribute of said scalable vector object comprises a description of said object.

10. The method of presenting an electronic document of claim 7 wherein said parsed attribute of said scalable vector object is a text attribute of said object.

11. A method of presenting an electronic document to a computer user, said electronic document comprising a scalable vector object including at least one attribute, said method comprising the steps of:
(a) parsing an attribute of said scalable vector object;
(b) converting said parsed attribute to at least one tactile symbol; and
(c) presenting at least one tactile symbol to said computer user.

12. The method of presenting an electronic document of claim 11 wherein said parsed attribute of said scalable vector object comprises a name of said object.

13. The method of presenting an electronic document of claim 11 wherein said parsed attribute of said scalable vector object comprises a description of said object.

14. The method of presenting an electronic document of claim 11 wherein said parsed attribute of said scalable vector object is a text attribute of said object.

15. A method of presenting an electronic document to a computer user, said electronic document comprising a scalable vector object including at least one attribute, said method comprising the steps of:
(a) parsing an attribute of a first scalable vector object;
(b) if said first scalable vector object is associated with a second scalable vector object, parsing an attribute of said second scalable vector object; and
(c) if said first scalable vector object is not co-located with said second scalable vector object, signaling a location of said second scalable vector object to said computer user.

16. The method of presenting an electronic document of claim 15 wherein said step of signaling said location of said second scalable vector object to said computer user, if said first scalable vector object is not co-located with said second scalable vector object, comprises the steps of:
(a) comparing at least one attribute of said first scalable vector object to at least one attribute of said second scalable vector object; and
(b) presenting an audible signal to said computer user indicating at least one of a horizontal direction and a vertical direction from a location of said first scalable vector object to said location of said second scalable vector object.

17. The method of presenting an electronic document of claim 16 further comprising the step of presenting an audible signal to said computer user indicating at least one of a horizontal distance and a vertical distance from said location of said first scalable vector object to said location of said second scalable vector object.

18. The method of presenting an electronic document of claim 15 wherein said step of signaling said location of said second scalable vector object to said computer user, if said first scalable vector object is not co-located with said second scalable vector object, comprises the steps of:
(a) comparing at least one attribute of said first scalable vector object to at least one attribute of said second scalable vector object; and
(b) presenting a tactile signal to said computer user indicating at least one of a horizontal direction and a vertical direction from a location of said first scalable vector object to said location of said second scalable vector object.

19. The method of presenting an electronic document of claim 18 further comprising the step of presenting a tactile signal to said computer user indicating at least one of a horizontal distance and a vertical distance from said location of said first scalable vector object to said location of said second scalable vector object.

20. A method of presenting an electronic document to a computer user, said electronic document comprising a scalable vector object including at least one attribute, said method comprising the steps of:
(a) parsing an attribute of said scalable vector object;
(b) determining a location of a display pointer; and
(c) if said display pointer and said scalable vector object are not co-located, presenting an audible signal to said computer user indicating at least one of a horizontal distance and a vertical distance from said location of said display pointer to said location of said scalable vector object.

21. The method of presenting an electronic document of claim 20 further comprising the step of presenting a tactile signal to said computer user indicating at least one of a horizontal distance and a vertical distance from said location of said display pointer to said location of said scalable vector object.

22. The method of presenting an electronic document of claim 21 further comprising the step of moving said display pointer to a location of said scalable vector object defined by said parsed attribute.

23. The method of presenting an electronic document of claim 20 further comprising the step of moving said display pointer to a location of said scalable vector object defined by said parsed attribute.

24. A method of presenting an electronic document to a computer user, said electronic document comprising a scalable vector object including at least one attribute, said method comprising the steps of:
(a) parsing an attribute of said scalable vector object;
(b) determining a location of a display pointer; and
(c) if said display pointer and said scalable vector object are not co-located, moving said display pointer to a location of said scalable vector object defined by said parsed attribute.

25. A method of presenting an electronic document to a computer user, said electronic document comprising a scalable vector object defined by an attribute, said method comprising the steps of:
(a) parsing said attribute;
(b) causing presentation of a representation of said document to said user, said representation of said document including at least one Braille symbol representing said scalable vector object if said attribute satisfies a criterion; and
(c) if said attribute does not satisfy said criterion, causing presentation of another representation of said document to said user, said another representation of said document including another tactile symbol representing said scalable vector object.

26. The method of presenting an electronic document to a computer user of claim 25 wherein the steps of presenting said representation of said document including at least one Braille symbol representing said scalable vector object if said attribute satisfies a criterion and if said attribute does not satisfy said criterion, presenting another representation of said document including another tactile symbol representing said scalable vector object comprise the steps of:
(a) transcoding said scalable vector object to a Braille symbol object, said Braille symbol object including at least one Braille symbol representing text included in said scalable vector object;
(b) replacing said scalable vector object with said Braille symbol object if a dimension specified in an attribute of said Braille symbol object is no larger than a dimension specified in an attribute of said scalable vector object; and
(c) replacing said scalable vector object with another object specifying said another tactile symbol if said dimension of said Braille symbol object is larger than said dimension specified for said scalable vector object.

27. The method of presenting an electronic document to a computer user of claim 26 further comprising the step of altering a resolution of said another tactile symbol if a dimension of said another tactile symbol specified in an attribute of said another object is larger than a dimension specified in an attribute of said scalable vector object.

28. A method of presenting an electronic document to a computer user, said electronic document comprising a scalable vector text object, said method comprising the steps of:
(a) parsing an attribute of said scalable vector text object;
(b) transcoding said scalable vector text object to a Braille symbol object, said Braille symbol object including at least one Braille symbol representing text included in said scalable vector text object;
(c) replacing said scalable vector text object with said Braille symbol object if a dimension specified in an attribute of said Braille symbol object is no larger than a dimension specified in an attribute of said scalable vector text object;
(d) if said dimension of said Braille symbol object is larger than said dimension specified for said scalable vector text object, determining if a receptacle object is associated with said scalable vector text object;
(e) replacing said scalable vector text object with said Braille symbol object if a dimension specified in an attribute of said Braille symbol object is no larger than a dimension specified in an attribute of said receptacle object; and
(f) replacing said scalable vector text object with another object specifying another tactile symbol if said dimension of said Braille symbol object is larger than said dimension specified for said receptacle object.

29. The method of presenting an electronic document to a computer user of claim 28 further comprising the step of altering a resolution of said another tactile symbol if a dimension of said another tactile symbol specified in an attribute of said another object is larger than a dimension specified in an attribute of said container object.

30. A method of locating a scalable vector object in an electronic document, said method comprising the steps of:
(a) parsing an attribute specifying a scalable vector object;
(b) presenting at least one of an audible and a tactile identification of said scalable vector object to a computer user; and
(c) if said computer user responds to one of said audible and said tactile identifications of said scalable vector object, moving a display pointer to a location on a display coincident to a displayed location of said identified scalable vector object.

31. The method of locating a scalable vector object of claim 30 wherein the step of moving a display pointer to a location on a display coincident to a displayed location of said identified scalable vector object if said computer user responds to one of said audible and said tactile identifications of said scalable vector object comprises the steps of:
(a) determining a present position of said display pointer;
(b) comparing said present position of said display pointer to at least one location attribute of said scalable vector object, said location attribute specifying a displayed location of said scalable vector object; and
(c) displaying said display pointer in a new position, said new position being displaced in a direction of said displayed location of said scalable vector object from said present position of said display pointer.

32. The method of presenting an electronic document of claim 30 further comprising the step of presenting an audible signal to said computer user indicating at least one of a horizontal distance and a vertical distance from said location of said display pointer to said location of said scalable vector object.

33. A writer for converting an electronic document having a format other than a scalable vector graphic format to an electronic document having a scalable vector graphic format, said writer comprising:
(a) a virtual printer interface receiving a print stream including data representing said electronic document having a format other than a scalable vector graphic format and determining a print stream format for said print stream;
(b) a printer language parser receiving said print stream in said print stream data format and parsing said print stream into at least one field and a datum corresponding to said field;
(c) a virtual printer receiving said field and said corresponding datum from said printer language parser; and
(d) an SVG engine scanning and extracting said field and said corresponding datum from data output by said virtual printer, transforming said field and corresponding datum according to said scalable vector graphic format, and outputting an electronic document including said field and said corresponding data in said scalable vector graphic format; said SVG engine inserting an editable text element in said electronic document at a location directed by a user.

34. A method of creating a scalable vector graphic document comprising the steps of:
(a) determining a print stream format for a print stream representing an electronic document;
(b) parsing said print stream into at least one field and a datum corresponding to said field;
(c) extracting said field and said corresponding datum;
(d) transforming said field and said corresponding datum according to a scalable vector graphic format; and
(e) inserting an editable text element in said document at a location designated by a user.
